(19) United States
(12) Patent Application Publication
(10) Pub. No.: US 2017/0170460 A1
(43) Pub. Date: Jun. 15, 2017

(54) CATHODE COMPOSITIONS AND RELATED ELECTROCHEMICAL CELLS

(71) Applicant: General Electric Company, Schenectady, NY (US)

(72) Inventors: Thomas Martin Angeliu, Clifton Park, NY (US); Job Thomas Rijssenbeek, Niskayuna, NY (US); Andrey Meshkov, Niskayuna, NY (US)

(21) Appl. No.: 14/969,759

(22) Filed: Dec. 15, 2015

(51) Int. Cl. H01M 4/36; H01M 4/66; H01M 4/76; H01M 4/04; H01M 4/38

(52) U.S. Cl. CPC H01M 4/364; H01M 4/0435; H01M 4/38; H01M 4/765; H01M 4/664; H01M 2004/028

(57) ABSTRACT

A cathode composition is presented. The cathode composition includes an alkali metal halide and an electroactive metal. The electroactive metal includes a first population of particles that is present in a range at least about 50 weight percent of a total weight of the electroactive metal. A specific surface area of the first population of particles is lower than 0.2 m²/g. An electrochemical cell and an energy storage system including the cathode composition are also presented.

### BACKGROUND

The present disclosure generally relates to cathode compositions. More specifically, the present disclosure relates to cathode compositions for use in electrochemical cells. The disclosure also includes electrochemical cells that utilize such cathode compositions.

Metal halide batteries are widely employed for energy storage applications. Metal halide batteries including a molten sodium anode and a beta-alumina solid electrolyte are of considerable interest for use in industrial vehicles, telecommunication, utility, and uninterruptible power supply (UPS) devices. In addition to the anode, the battery cell includes a cathode that supplies/receives electrons during the charge/discharge of the battery. The cathodes of such batteries usually contain nickel, sodium chloride (NaCl), and a molten electrolyte, such as sodium tetrachloroaluminate (NaAlCl₄).

Current development of sodium-metal halide batteries is directed towards performance improvement and cycle life enhancement. Typically, when these batteries are discharged using high discharge current rates (e.g., at 110 W/cell for a 110 W-h cell), multiple discharge cycles may be carried out with no significant increase in the resistance, increase in the charging time, or loss of capacity of the batteries. However, when these batteries are discharged at low discharge currents, which may be required for several utility and backup applications, the batteries generally degrade relatively rapidly leading to reduced performance (e.g., significant capacity loss, slow charging, and the like), and thus reduced cycle life.

There continues to be a growing need in the art for an improved solution to increase cycle life of metal halide batteries.

### BRIEF DESCRIPTION

In one embodiment, a cathode composition is presented. The cathode composition includes an alkali metal halide and an electroactive metal. The electroactive metal includes a first population of particles that is present in a range at least about 50 weight percent of a total weight of the electroactive metal. A specific surface area of the first population of particles is lower than 0.2 m²/g.

Another embodiment is directed to an electrochemical cell. The electrochemical cell includes a first compartment that includes an alkali metal; and a second compartment that includes a cathode composition. The cathode composition includes:

an alkali metal halide;

an electroactive metal comprising a first population of particles present in a range at least about 50 weight percent of a total weight of the electroactive metal, wherein a specific surface area of the first population of particles is lower than 0.2 m²/g;

an electrolyte comprising a complex metal halide; and

a solid separator capable of transporting alkali metal ions between the first compartment and the second compartment.

An energy storage system including a plurality of the electrochemical cells is also provided in one embodiment.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a scanning electron micrograph of a gas atomized nickel powder;

FIG. 2 is a scanning electron micrograph of a carbonyl nickel metal powder (Ni 123);

FIG. 3 is a scanning electron micrograph of a carbonyl nickel metal powder (Ni 255);

FIG. 4 is a schematic, cross-sectional view of a portion of an electrochemical cell, in accordance with some embodiments of the invention;

FIG. 5 is a schematic, cross-sectional view of a portion of an electrochemical cell, in accordance with some embodiments of the invention;

FIG. 6 shows a graph comparing discharge capacities of a comparative electrochemical cell and experimental electrochemical cells, in accordance with some embodiments of the invention;

FIG. 7 shows a graph comparing percentage of initial capacity of a comparative electrochemical cell with that of experimental electrochemical cells, in accordance with some embodiments of the invention.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

As used herein, the terms “cathode”, “cathode composition” and “cathode material”, which may all be used interchangeably, refer to a material that supplies electrons during charge and is present as part of a redox reaction. The terms, “anode”, “anode composition” and “anode material”, which may all be used interchangeably, refer to a material that accepts electrons during charge and is present as part of the redox reaction.

As used herein, the term “electrolyte” refers to a medium that provides an ion transport mechanism between the cathode and anode of an electrochemical cell. Additives that facilitate the primary redox process, but do not themselves provide the primary redox process, are distinguished from the electrolyte itself. The electrochemical cell may also be referred to as an energy storage device, and these terms may be used interchangeably.

As discussed in detail below, some embodiments of the disclosure provide a cathode composition that includes an alkali metal halide and an electroactive metal. The electroactive metal includes a first population of particles that is present in a range at least about 50 weight percent of a total weight of the electroactive metal. A specific surface area of the first population of particles is lower than 0.2 m²/g.

The terms, as used herein, “first population of particles” and “second population of particles” refer to either prepared or procured powder materials of desired specific surface areas. As used herein, the term “specific surface area” refers to a total surface area of particles per unit mass. The specific surface area of a powder material may depend on the particles sizes and their shapes, and can be calculated from a particle size distribution while making some assumption about the shape of the particles. Typically, a fine particle size distribution (i.e., smaller particles) has higher surface area than a coarse particle size distribution (i.e., larger particles). However, the relationship between the particle size and the surface area in a material may be complex due, in part, to the complicated particle shapes of powder materials. Thus, powder materials of different surface areas may have overlapping particle size distributions. Though, various particle sizes of different powder materials are described in the present specification, the main parameter to differentiate a powder material from another powder material is surface area.

Moreover, the particle size distribution of a powder material may be determined from a variety of particle size analysis methods and may be described by a variety of different metrics. For example, particle sizes can be described by using “d values” or “Fisher sub-sieve size.” The “d values” such as d₉₀, d₅₀ and d₁₀ values are generally used to represent a particle size corresponding to cumulative size distribution, respectively, at 90%, 50%, or 10%, which indicates that 90%, 50%, or 10% of particles of a powder material are below the d₉₀, d₅₀ and d₁₀ values. The value d₅₀ is also known as the median diameter or the medium particle size of a particle size distribution. Fisher sub-sieve size usually represents an average particle size of a powder material. Typically, the terms “average particle size” and “median particle size” have substantially similar values.

In some embodiments, the electroactive metal and the alkali metal halide may be present in the form of granules in the cathode composition. As used herein, the terms “granules” and “cathode granules” refer to agglomerates or particulates of one or more shapes, sizes and geometries. Further, the terms “granules” and “cathode granules” may be used interchangeably throughout the application. In one embodiment, the granules may be in the shape of a sphere, a cube, a plate, a flake, a whisker, or combinations thereof. In some embodiments, a cross sectional geometry of the granules may be circular, ellipsoidal, triangular, rectangular, polygonal, or combinations thereof. While in some embodiments, the granules may have one or more of the aforementioned shapes and/or geometries. In some other embodiments, the granules may be irregular in shape. In certain embodiments, the cathode granules include the electroactive metal, the alkali metal halide, and one or more additives of the cathode composition (as described below).

The alkali metal halide is present in the cathode composition to promote the desired electrochemical reaction for an electrochemical cell of interest. In some embodiments, the cathode composition includes at least about 25 weight percent alkali metal halide of a total weight of the granules. In some particular embodiments, the amount of the alkali metal halide is in a range from about 30 weight percent to about 40 weight percent of the granules, based on the total weight of the granules.

The alkali metal halide may include one or more halides selected from chloride, bromide, fluoride, and iodide. In some embodiments, the halides of one or more of sodium, potassium, or lithium are used in the alkali metal halide. In some embodiments, the cathode composition includes a sodium halide, potassium halide, lithium halide, or combinations thereof. In some embodiments, the cathode composition includes at least one halide selected from sodium chloride, sodium iodide, sodium bromide, and sodium fluoride.

The term “electroactive metal,” as used herein, is a metal that oxidizes in a molten electrolyte (for example, molten sodium tetrachloroaluminate), resulting in a metal halide salt during an electrochemical reaction. In some instances, the metal halide salt is formed above the oxidation potential of aluminum (about 1.58 V vs. Na/Na ion), and below the oxidation potential of chloride (about 4.15 V vs. Na/Na ion). In some embodiments, the cathode composition includes an electroactive metal selected from the group consisting of nickel, iron, chromium, copper, manganese, zinc, cobalt, and combinations thereof. In some embodiments, the electroactive metals are obtained as powders from various commercial sources.

In certain embodiments, the electroactive metal is present in an elemental form during preparation of the granules or the cathode composition. In some embodiments, the cathode composition may optionally include a salt of the electroactive metal. In one embodiment, the electroactive metal salt may be in the form of a sulfide or halide of the electroactive metal. In one embodiment, the electroactive metal salt may be in the form of a halide salt.

An amount of the electroactive metal present in the cathode composition may be suitable to perform the electrochemical reaction in the electrochemical cell, and form an electrically conductive network in the cathode. In some embodiments, an amount of the electroactive metal is in a range from about 50 weight percent to about 70 weight percent, based on the total weight of the cathode granules. In some embodiments, the amount of electroactive metal is in a range from about 55 weight percent to about 65 weight percent, based on a total weight of the cathode composition.

In some specific embodiments, the cathode composition includes nickel. Nickel may be the most suitable/desirable electroactive metal, in view of various attributes, including cost, availability, the high reduction potential (“redox potential”) of nickel relative to sodium/sodium ion (˜2.58 V); and the low solubility of the nickel cations in the cathode composition. As noted previously, nickel further forms the electrically conductive network in the cathode. In some embodiments, the cathode composition includes at least two electroactive metals. For example, the cathode composition may include nickel and iron. In these instances, iron is present from about 1 weight percent to about 15 weight percent, based on the total weight of the electroactive metal in the cathode granules.

As noted previously, the electroactive metal includes a first population of particles that is present at least about 50 weight percent of the total weight of the electroactive metal. In some embodiments, the first population of particles is up to 100 weight percent of the total weight of the electroactive metal. In some embodiments, the first population of electroactive particles is present in a range from about 50 weight percent to about 95 weight percent, based on the total weight of the electroactive metal. In some specific embodiments, the first population of electroactive particles is present in a range from about 65 weight percent to about 90 weight percent, based on the total weight of the electroactive metal.

In some embodiments, the specific surface area of the first population of particles is lower than 0.2 m²/g. In some embodiments, the specific surface area of the first population of particles is in a range from about 0.05 m²/g to about 0.18 m²/g. In some specific embodiments, the specific surface area of the first population of particles is in a range from about 0.1 m²/g to about 0.15 m²/g. It may be noted that the terms “first population of particles,” “first population of electroactive metal particles,” and “low surface area electroactive metal particles” may be used interchangeably throughout the specification.

The first population of electroactive metal particles may have any shape, including, for example, spherical, cuboidal, lenticular, flaky and other shapes. In some specific embodiments, the first population of electroactive metal particles may be substantially spherical in shape. In some embodiments, the first population of electroactive metal particles may have a particle size distribution having a d₅₀ value in a range from about 5 microns to about 20 microns. In some embodiments, the first population of electroactive metal particles may have a particle size distribution having a d₅₀ value in a range from about 10 microns to about 20 microns.

In some particular embodiments, the first population of electroactive metal particles consists essentially of nickel. The term “consists essentially of” as used herein means that the first population of electroactive metal particles primarily includes nickel and does not include additional materials, such as, iron or other metal particles that may alter the properties of the first population of particles. In some instances, the first population of particles may include a small quantity (less than about 0.1 percent) of contaminants. In some particular embodiments, the first population of particles of the cathode granules is made of nickel.

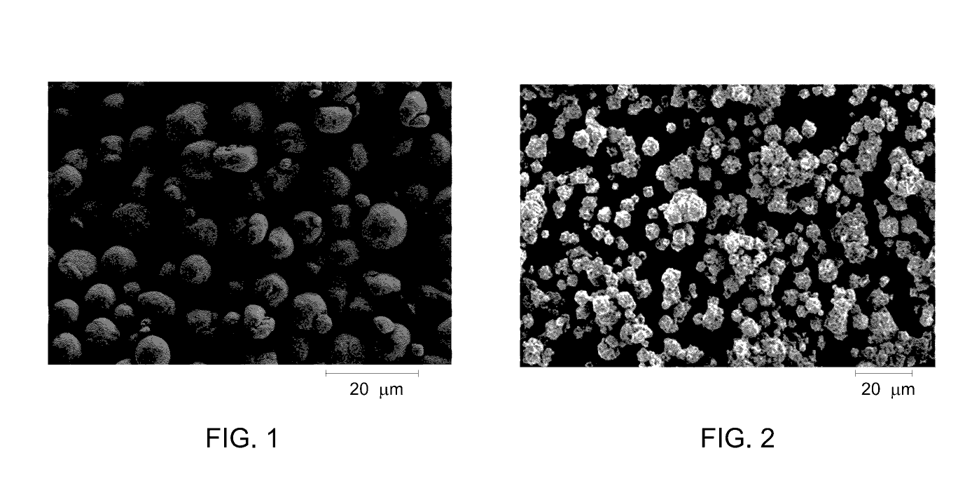

One suitable example of the low surface area electroactive metal particles may include gas atomized nickel powder. FIG. 1 shows scanning electron micrograph (SEM) of commercially available gas atomized nickel powder with a d₅₀ value of about 11 microns. This gas atomized nickel powder has a specific surface area of about 0.1 m²/g. In some embodiments, a metal powder of specific surface area greater than 0.2 m²/g may be treated at a predetermined temperature or milled to reduce the specific surface area below 0.2 m²/g.

In some embodiments, the electroactive metal further includes a second population of particles. As used herein, the term “second population of particles” may also be referred to as “second population of electroactive metal particles” or “high surface area electroactive metal particles.” In some embodiments, a specific surface area of the second population of particles is greater than about 0.4 m²/g. In some embodiments, the specific surface area of the second population of particles is in a range from about 0.4 m²/g to about 2.0 m²/g. In some particular embodiments, the specific surface area of the second population of particles is in a range from about 0.5 m²/g to about 1.5 m²/g. An amount of the second population of electroactive particles may be less than about 50 weight percent, based on the total amount of the electroactive metal in the cathode granules. In some embodiments, the amount of the second population of electroactive particles is in a range from about 1 weight percent to about 30 weight percent, based on the total amount of the electroactive metal in the cathode granules.

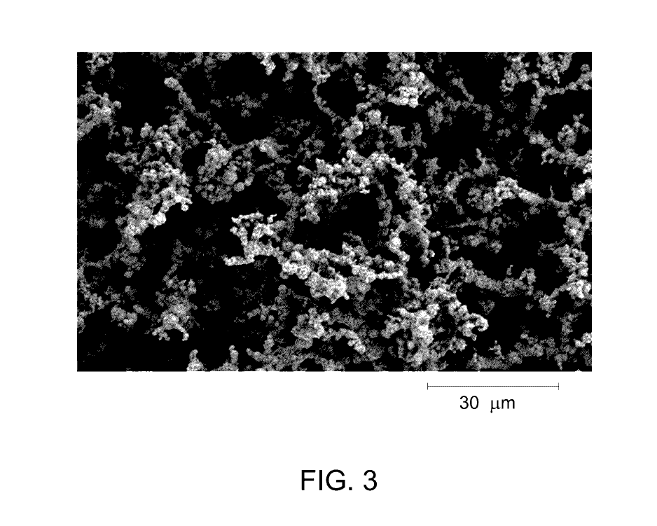

The second population of electroactive particles may have any shape, including, for example, spherical, cuboidal, lenticular, filamentary, flaky and other shapes. In some embodiments, the second population of electroactive metal particles has an average particle size in a range from about 0.1 microns to about 5 microns. In some embodiments, the second population of electroactive metal particles may have an irregular morphology, such as, but not limited to, irregular spiky morphology. One example of the second population of electroactive metal particles includes carbonyl nickel (Ni123) powder. FIG. 2 shows scanning electron micrograph (SEM) of commercially available Ni123 powder having a specific surface area of about 0.5 m²/g. This nickel powder has spiky morphology with a Fisher sub-sieve size in a range from about 3.0 microns to about 7.0 microns. In some embodiments, the second population of electroactive particles includes particles that form aggregates having three dimensional filamentary or chain-like morphology. For example, FIG. 3 shows a scanning electron micrograph of commercially available carbonyl nickel powder (Ni 255) having a specific surface area of about 0.6 m²/g. In these instances, the fisher sub-sieve size of the particles of Ni 255 ranges from about 2 microns to about 3 microns.

The cathode composition may further include some additives that beneficially affect the performance of the electrochemical cell. Such performance additives may increase the ionic conductivity, increase or decrease the solubility of the charged cathode species, improve wetting of a solid separator by a molten electrolyte, or prevent ripening of the cathode composition. In some embodiments, an additive may be present in the cathode composition in an amount less than about 1 weight percent (e.g., with a minimum level of about 0.1 weight percent), based on a total weight of the cathode composition. Examples of such additives include one or more additional metal halides, e.g., sodium iodide, sodium fluoride and sodium bromide. In some specific embodiments, sodium iodide may be present in a range from about 0.1 weight percent to about 0.9 weight percent, based on the total weight of the alkali metal halides present in the cathode composition. In some embodiments, sodium fluoride is present in a range from about 0.1 weight percent to about 3 weight percent, based on the total weight of the alkali metal halide present in the cathode composition. Some other examples of such additives include titanium oxide and aluminum oxide.

In some embodiments, the cathode composition may further include sulfur. Sulfur may be present in the form of molecular sulfur or a sulfur-containing compound, such as a metal sulfide. In some embodiments, the cathode granules include a sulfur containing compound for example, iron sulfide. In some embodiments, a molar ratio of the electroactive metal to the sulfur (e.g., present in the metal-containing compound) in the cathode granules may range from about 1.5:1 to about 10:1.

In some embodiments, the cathode composition may include carbon. In some embodiments, carbon is present in an amount up to about 5 weight percent, based on a total weight of the cathode granules. Furthermore, carbon may be present in the form of carbon black or graphite.

In some embodiments, the cathode composition further includes an electrolyte, for example a molten electrolyte. The cathode granules may be infused with the molten electrolyte. The molten electrolyte enables the transport of the alkali ions from a solid separator (described later) to the cathode, and vice-versa. In some embodiments, the molten electrolyte includes a complex metal halide having a melting temperature in a range from about 120 degrees Celsius to about 300 degrees Celsius. In one embodiment, the molten electrolyte includes a binary salt including an alkali metal halide and an aluminum halide. In a specific embodiment, the molten electrolyte is sodium tetrachloroaluminate (NaAlCl₄). In some embodiments, the molten electrolyte may include at least one additional metal halide, and forms a ternary or quaternary electrolyte.

In addition to the components discussed above, the cathode composition may include a number of other constituents, in some embodiments. As an example, aluminum may be included in the cathode composition in a form other than its form in the electrolyte salt, and other than as aluminum halide. In some embodiments, aluminum may be added in the elemental form, e.g., aluminum metal flakes or particles. In some embodiments, the amount of elemental aluminum present in the cathode composition may be in a range from about 0.1 weight percent to about 1.5 weight percent, based on the total weight of the cathode granules.

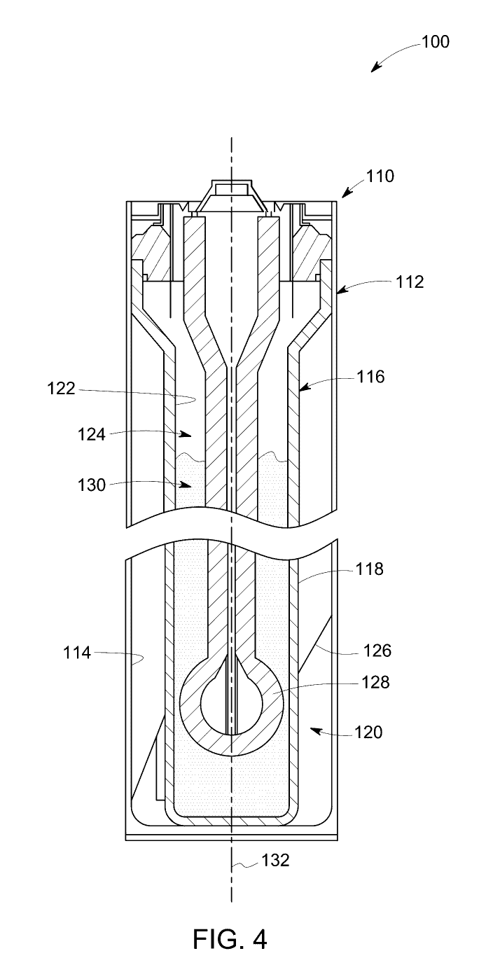

Another embodiment of the disclosure is directed to an electrochemical cell (that may also be referred to as an energy storage device). Referring to FIG. 4, an electrochemical cell 100 is presented. More particularly, a cross-sectional view 110 of the cell is depicted. The cell 100 includes a housing 112. The housing 112 of the cell 100 may be sized and shaped to have a cross-sectional profile that is square, polygonal, or circular, for example. The housing may be formed from a material including a metal, ceramic, a composite; or combinations thereof. In some embodiments, a suitable metal may include nickel, iron, molybdenum, or an alloy thereof, e.g. steel.

The housing 112 has an interior surface 114, defining a volume. A separator 116 is disposed inside the housing 112. The separator 116 has a first surface 118 that defines a first compartment 120 (for example, an anode compartment); and a second surface 122 that defines a second compartment 124 (for example, a cathode compartment or a cathode compartment). In one embodiment, the first compartment or the anode compartment 120 contains an anode material (not shown); and the second compartment or the cathode compartment 124 contains a cathode composition 130. In some embodiments, the cathode composition 130 includes an electrolyte, an alkali metal halide and an electroactive metal. The electroactive metal includes a first population of particles that is present in a range at least about 50 weight percent of the total weight of the electroactive metal. A specific surface area of the first population of particles is lower than 0.2 m²/g. Various details of the cathode composition are described previously.

The first compartment 120 is in ionic communication with the second compartment 124 through the separator 116. As used herein, the phrase “ionic communication” refers to the traversal of the ions between the first compartment 120 and the second compartment 124, through the separator 116. In some embodiments, the separator is capable of transporting alkali metal ions between the anode material and the cathode composition 130. Suitable alkali metal ions may include one or more of sodium, lithium and potassium. In specific embodiments, the alkali metal ions include sodium.

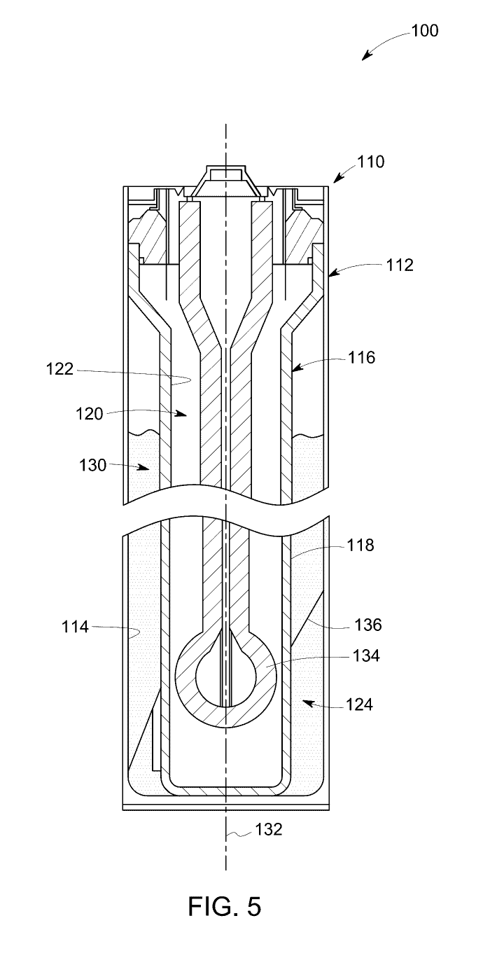

FIG. 4 depicts embodiments wherein the second compartment 124 is disposed within the first compartment 120. In such instances, the cathode compartment 124 is disposed within the anode compartment 120. In some other embodiments, the first compartment 120 may be disposed in the second compartment 124, as indicated in FIG. 5. In such instances, the anode compartment 120 is disposed within the cathode compartment 124.

Typically, the anode compartment 120 is essentially empty in the ground state (uncharged state) of the cell 100. The anode compartment 120 is then filled with an alkali metal from the reduced alkali metal ions that move from the cathode compartment 124 to the anode compartment 120 through the separator 116, during charge of the cell 100. The anode compartment 120 may receive and store a reservoir of the anode material, in some embodiments. In one embodiment, the anode material includes an alkali metal. Non-limiting examples of the anode material may include lithium, sodium, or potassium. The anode material is usually molten during use. In one embodiment, the anode material is molten sodium metal.

In some embodiments, the anode material may include one or more additives. Additives suitable for use in the anode material may include a metallic oxygen scavenger. Suitable metal oxygen scavengers may include one or more of manganese, vanadium, zirconium, aluminum, or titanium. Other useful additives may include materials that increase wetting of the separator surface defining the anode compartment, by the molten anode material. Additionally, some additives or coatings may enhance the contact or wetting between the separator and the current collector, to ensure substantially uniform current flow throughout the separator.

The cathode composition 130 may be self-supporting or may be liquid/molten, in some embodiments. In one embodiment, the cathode composition 130 is disposed on an electronically conductive support structure. The support structure, itself may not undergo any chemical reaction during the charge/discharge, and may simply support the cathode material during the chemical reactions. The support structure may be present in a number of forms, such as a foam, a mesh, a weave, a felt, or a plurality of packed particles, fibers, or whiskers. In one embodiment, a suitable support structure may be formed from carbon or a metal.

With continued reference to FIGS. 4 and 5, in some embodiments, the electrochemical cell 100 may include a plurality of current collectors, including a negative current collector 126/134 (also referred to as the anode current collector), and a cathode current collector 128/136 (also referred to as the cathode current collector). The anode current collector 126/134 is in electrical communication with the anode compartment 120, and the cathode current collector 128/136 is in electrical communication with the contents of the cathode compartment 124. Suitable materials for the anode current collector include iron, aluminum, tungsten, titanium, nickel, copper, molybdenum, carbon and combinations thereof. The cathode current collector may be in various forms, for example, rod, sheet, wire, paddle, or mesh. Suitable materials for the cathode current collector include platinum, palladium, gold, nickel, copper, carbon, tungsten, molybdenum and combinations thereof. The current collector may be plated or clad.

As noted above, a separator 116 (FIGS. 4 and 5) is disposed within the volume of the housing 112. In some embodiments, the separator 116 is a solid separator. In some embodiments, the solid separator is an alkali metal ion conductor solid electrolyte capable of transporting alkali metal ions between the first compartment 120 and the second compartment 124. Suitable materials for the solid separator may include an alkali-metal-beta-alumina, alkali-metal-beta“-alumina, or a silicophosphate (e.g., NASICON: Na₃Zr₂Si₂PO₁₂). In some embodiments, the solid separator may include a beta-alumina, a beta”-alumina, or a combination thereof. In some embodiments, a portion of the separator may include alpha alumina (a non-ionic-conductor). The portion of the separator having alpha alumina may help with sealing and/or fabrication of the cell. In some embodiments, the separator may be stabilized by addition of small amounts of one or more dopants. The dopants may include one or more oxides selected from the group consisting of lithia, magnesia, zinc oxide, and yttria. These dopants that act as stabilizers may be used alone or in combination or with other materials.

In some embodiments, the separator may be sized and shaped to provide a maximum surface area for the alkali metal ion transport. In one embodiment, the separator may be a tubular container having at least one wall of a selected thickness; and a selected ionic conductivity. In some embodiments, the thickness of the separator wall may be less than about 5 millimeters. In some embodiments, the tubular separator 116 may have a cross-sectional profile normal to a vertical axis 132 of the housing 112 (FIGS. 4 and 5). Examples of profiles/shapes include a circle, a triangle, a square, a cross, a cloverleaf, or a star. In one embodiment, the separator 116 may have a length (along the vertical axis 132) to width ratio that is greater than about 1:10. In one embodiment, the length to width ratio of the separator is in a range of from about 1:10 to about 1:5, although other relative dimensions are possible, as described in U.S. Publication No. 20120219843A1.

Although not illustrated, in some embodiments, one or more shim structures may be disposed within the volume of the housing. The shim structures may support the separator within the volume of the housing. The shim structures may protect the separator from vibrations caused by the motion of the cell during use, and thus reduce or eliminate the movement of the separator relative to the housing. In one embodiment, a shim structure may also function as a current collector.

In some instances, the operating temperature of the cell may be in a range from about 240 degrees Celsius to about 350 degrees Celsius.

The electrochemical cell is usually assembled in the discharged state. Applying a voltage between the anode and the cathode of the cell can charge the cell. In some embodiments, the sodium chloride in the cathode composition (or the cathode material) dissolves into the electrolyte to form the sodium ions and the chloride ions. The sodium ions, under the influence of an applied electrical potential, conduct through the electrolyte and the separator to combine with the electrons from the external circuit to form the sodium metal electrode (i.e., the anode), and the chloride ions react with the electroactive metal to form a metal chloride and donate electrons back to the external circuit. During discharge, the sodium metal electrode, donates electrons to the load and the sodium ions conduct back through the separator reversing the reaction. The cell reactions are as follows (charging is to the right):

At cathode:nNaCl+M [symbol] MClₙ+nNa⁺+ne⁻

At anode:nNa⁺+ne⁻ [symbol] nNa

Overall:nNaCl+M [symbol] MClₙ+nNa

Conventional knowledge in battery technology suggests that a high surface area electroactive metal is desirable in the cathode composition. Typically, carbonyl nickel (Ni 255) powder that includes filamentary chain-like morphology (discussed previously), is used in conventional cathode compositions. However, the present disclosure presents a cathode composition that includes low surface area electroactive metal particles i.e., having specific surface area lower than 0.2 m²/g (as discussed herein). A low surface area electroactive metal powder exhibits a lower electrochemical activity than that of a high surface area electroactive metal powder. Accordingly, the first population of electroactive metal particles of low surface area may provide a reduced electrochemical activity as compared to that of the high surface area electroactive metal particles. The inventors of the present disclosure advantageously suggested that the reduced electrochemical activity of the low surface area electroactive metal particles may aid in reducing the capacity loss in an electrochemical cell as described in greater detail below. In addition, the low surface area electroactive metal particles may provide relatively more stable electrically conductive network in the cathode composition as compared to the conventional high surface area particles (for example, commercially available filamentary nickel powder Ni 255). Moreover, the presence of the high surface area electroactive metal particles along with the low surface area electroactive metal particles may enable tuning the electrochemical activity in the cathode composition.

In some embodiments, the electrochemical cell may be conditioned using a conditioning cycle under a temperature before starting the electrochemical cell for the normal cell operation. In some embodiments, the cathode composition is substantially free of the second population of electroactive particles in the initial charging/discharging cycles (conditioning cycles). After performing the conditioning cycle(s), the cathode composition may include an amount of the second population of electroactive particles along with the first population of electroactive particles.

Embodiments of the present disclosure, present a cathode composition that includes a low surface area electroactive metal along with the other constituents of the composition. The inventors of the present disclosure have observed that by using low surface area electroactive metal, as disclosed herein, the cell showed a reduced capacity loss when the cell is discharged at low discharge rates. These observations may be in opposition to conventional knowledge that suggested that a low electroactive surface area was detrimental to the battery performance and a higher electroactive surface area (>0.2 m²/g) was desirable for improved performance in the high power battery designs. Without being bound by any theory, it is believed that these results may be attributed to the reduced electrochemical activity of the electroactive metal and improved stability of the electrically conductive network in the cathode composition due to the presence of low surface area electroactive metal particles. Some of these results are shown and described in detail below in the Example section. These improvements generally contribute to an improved cycle life of the cell.

In some embodiments, the cell having the low surface area electroactive metal is capable of retaining its capacity for more cycles at low discharge rates as compared to a similar conventional cell having a high surface area electroactive metal.

Another embodiment of the disclosure is directed to an energy storage system (that may also be referred to as a battery). In some embodiments, a plurality of the electrochemical cells as described herein, may be organized into an energy storage system, for example, a battery. Each electrochemical cell may be considered a rechargeable electrochemical cell. Multiple cells may be connected in series or parallel, or in a combination of series and parallel. For convenience, a group of coupled cells may be referred to as a module or pack. The ratings for the power and energy of the module may depend on such factors as the number of cells, and the connection topology in the module. Other factors may be based on end-use application specific criteria. In some embodiments, the energy storage system may further include a heat management device to maintain the temperature within specified parameters.

In some embodiments, the electrochemical cells illustrated herein may be rechargeable over a plurality of charge-discharge cycles. In general, the electrochemical cell may be employed in a variety of applications; and the plurality of cycles for recharge may be dependent on factors such as charge and discharge currents, depth of discharge, cell voltage limits, and the like.

In some embodiments, the electrochemical cell as described herein may be used in combination with a primary battery, a secondary battery, a fuel cell, and/or an ultra-capacitor.

In one embodiment, the energy storage system is in the form of an uninterruptable power supply (UPS) device that provides power in case of a primary power loss. In one embodiment, the energy storage system is a part of a hybrid power system. In these embodiments, the energy storage system provides power when the primary power source (for example, a grid power, a solar photovoltaic, a wind turbine or a diesel generator) is unavailable, for example in weak-grid or off-grid applications. In one embodiment, the energy storage system is in the form of a battery that is used to minimize the fluctuations in a power output from an intermittent power source (for example, wind or solar energy source) or fluctuations in power demand (for example, a household, a commercial building, or an entire electrical grid).

### Examples

The examples presented below are intended to be merely illustrative and should not be construed to be any sort of limitation on the scope of the claimed invention. Unless specified otherwise, all of the components are commercially available from common chemical suppliers. Table 1 shows details of various materials that are used in assembling nickel/sodium chloride based experimental and comparative cells (described below).

TABLE 1

| Material | Source | Properties |
|---|---|---|
| Ni 255 (carbonyl nickel | Vale INCO | 97.9 percent pure, ~0.6 square meters per |
| metal powder) | | gram surface area, Fisher sub-sieve size |
| | | 2.0 to 3.0 micrometers |
| Ni 123 (carbonyl nickel | Vale INCO | 97.9 percent pure, ~0.5 square meters per |
| metal powder) | | gram surface area, 3.0 to 7.0 micrometers |
| | | Fisher sub-sieve size |
| 4SP −10 micron (gas | Novamet | 99.6 percent pure, SNP −10 micrometers, |
| atomized nickel metal | | d₁₀ 3.0 micrometers, d₅₀ 6.3 micrometers, |
| powder) | | d₉₀ 11.2 micrometers |
| SNP −20 + 10 micron (gas | Novamet | 99.6 percent pure, +10 micrometers and −20 |
| atomized nickel metal | | micrometers, d₁₀ 4.4 micrometers, d₅₀ |
| powder) | | 11.4 micrometers, d₉₀ 25.2 micrometers |
| SNP −250 Mesh +20 | Novamet | 99.6 percent pure, SNP −250 mesh, +20 |
| micron (gas atomized | | micrometers, d₁₀ 12.6 micrometers, d₅₀ |
| Nickel metal powder | | 20.8 micrometers, d₉₀ 34.6 micrometers |
| Sodium Chloride (NaCl) | Custom | 99.99 percent pure |
| | Powders Ltd, | |
| Sodium Fluoride (NaF) | Sigma | ~99 percent pure |
| | Aldrich | |
| Aluminum powder (Al) | Alfa Aesar | −100 + 325 mesh particle size, 99.97 |
| | Item #42919 | percent pure |
| Iron (metal iron powder) | Alfa Aesar | less than 10 micrometers particle size, |
| (Fe) | Item #00170 | 99.9 percent pure |
| Sodium iodide (NaI) | Sigma | ~99 percent pure |
| | Aldrich | |
| Iron sulfide (FeS) | Alfa Aesar | 99.9 percent pure |
| | Item #14024 | |

Five electrochemical cells (Cell 1-5) were assembled using the composition provided in Table 2 using different nickel metal powder types in each cell as provided in Table 3.

TABLE 2

| NaAlCl₄ | | Nickel | | Al | NaF | | FeS |
|---|---|---|---|---|---|---|---|
| (g) | NaCl (g) | (g) | Fe (g) | (g) | (g) | NaI (g) | (g) |
| 121.2 | 101.6 | 137.2 | 14.33 | 1.37 | 3.9 | 1.05 | 4.22 |

TABLE 3

| Cell description | Nickel metal powder type |
|---|---|
| Cell 1 | Ni255 - Carbonyl nickel metal powder (Vale) |
| Cell 2 | Ni 123 - Carbonyl nickel metal powder (Vale) |
| Cell 3 | 4SP-10 microns-Gas atomized nickel metal powder |
| | (Novamet) |
| Cell 4 | SNP −20 +10 microns -Gas atomized nickel metal |
| | powder (Novamet) |
| Cell 5 | SNP −250 Mesh +20 micron-gas atomized nickel |
| | metal powder (Novamet) |

### Example 1: Comparative Electrochemical Cell—Cell 1

Preparation of Cathode Composition with Ni255

Sodium chloride (NaCl) had a particle size distribution with 90% by mass less than about 75 micrometers by sieve analysis. The material was heat treated in an oven at 220° C. before use. Cathode materials, including nickel powder (Ni 255), sodium chloride, sodium fluoride, sodium iodide, iron, and aluminum powder (as per Table 2), were pressed at ambient room temperature (typically about 18° C.-25° C.), under a linear pressure of about 16-25 kN/cm, using an Alexanderwerk WP50N/75 Roll Compactor/Milling Machine. The resulting agglomerate was ground with a classifier mill into granules, and the fraction containing a granule size of about 0.325 to about 1.5 millimeters was used for the cell assembly.

### Preparation of Comparative Electrochemical Cell-Cell 1

The electrochemical cell used commercial hardware (GE Energy Storage Technology ML/3, Revision 2). A closed-end β″ alumina, separator tube with a cloverleaf cross-section separated the inner cathode compartment from the outer anode compartment. The outer wall of the anode was a carbon-steel can with a square profile. The can size was about 38 mm×38 mm×230 mm. The steel can was the current collector for the anode. A central U-shaped nickel rod was the current collector for the cathode. High temperature, hermetic seals were applied to the open top ends of the cathode and the anode. Details of this construction can be found in J. L. Sudworth, J. Power Sources 100 (2001) 149-163.

The cathode granules, prepared using the procedure mentioned above, were placed in the cloverleaf shaped β″-alumina tube through a fill hole at the top of the cell assembly, and the granule bed was densified by mechanical vibration. The cathode was then infiltrated with molten sodium tetrachloroaluminate NaAlCl₄ through the same fill hole at a temperature of about 280° C.; and the fill hole was then closed with a welded cap. Anhydrous, high-purity sodium tetrachloroaluminate was used as received (Aldrich #451584). Nickel tabs were brazed to the fill-hole cap and the steel can for electrification.

### Examples 2: Experimental Electrochemical Cells—Cells 2-5

Four electrochemical cells (Experimental electrochemical Cells 2, 3, 4, and 5) were constructed using the method described above in Example 1, except using the cathode compositions as described in Table 2. The comparative electrochemical cell (Cell 1) was prepared by using the cathode composition that includes Ni255. The cathode compositions for Experimental electrochemical cells (Cells 2, 3, 4, and 5) were prepared by using Ni 123 and gas atomized Ni (as shown in Table 2) during the premixing step of the granulation process.

### Testing of Electrochemical Cells:

All electrochemical cells were assembled in the discharged state. Each electrochemical cell was tested separately using the same standard test protocol.

The protocol included an initial maiden charge and discharge, a series of up to 25 full charge/discharge cycles to stabilize initial cell capacity (described previously as conditioning cycles), and a low discharge rate repetitive cycle designed to accelerate cell capacity loss. The cycling was periodically interrupted to characterize the capacity of the electrochemical cell using a reference performance cycle.

### Maiden Charge and Discharge Cycles

1. Starting at 100 mA and ramping up to 2.75 A over time, charge to 2.67V, then at 2.67V to a current of 500 mA, while at 330° C.
2. Reduce temperature to 300° C. and discharge at −4.5 A to 1.95V.

### Conditioning Cycles

3. Charge at 10 A to 2.67V, then at 2.67V down to 500 mA.
4. Discharge at −9.5 W to 1.95V.
5. Repeat steps 3 and 4, up to 25 times Accelerated test cycles
6. Charge at 10 A to 2.67V, then at 2.67V down to 500 mA or for 4.5 hours (total charge time)
7. Discharge at −6.3 W to 2.08V.
8. Repeat steps 6 and 7 until a cumulative discharged capacity reaches 425 Ah.

### Reference Performance Cycle

9. Charge at 10 A to 2.67V, then at 2.67V down to 500 mA.
10. Discharge at −4.6 A to 1.95 V.
11. Resume accelerated test cycles at step 6.

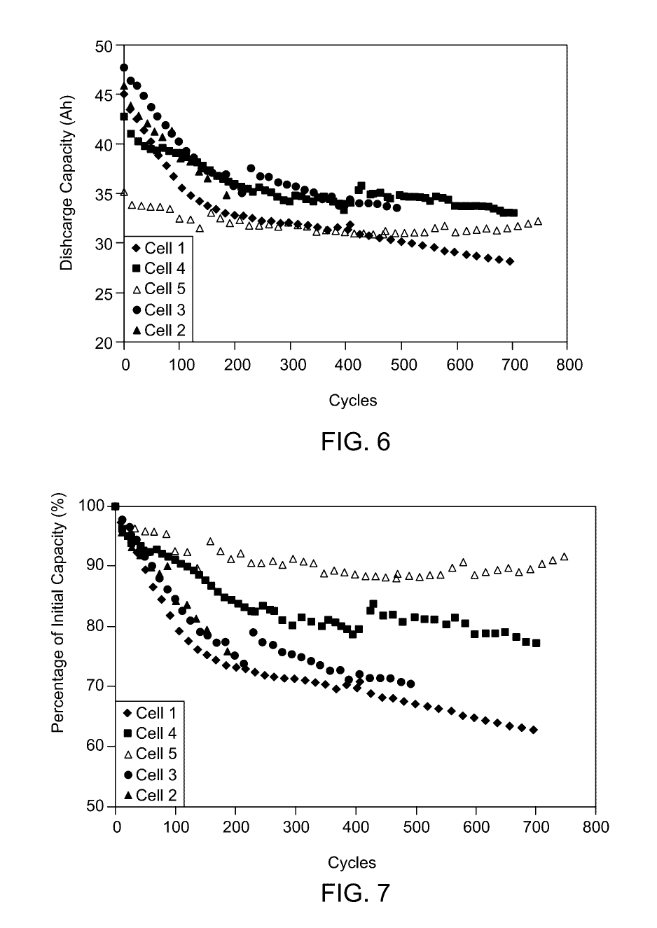

FIG. 6 represents the discharge capacity measured on the reference performance cycle (step 10) as a function of number of accelerated test cycles for Cells 1-5. FIG. 6 clearly shows a decrease in the initial rate of capacity loss for those cells that contain gas atomized nickel particles with specific surface area less than 0.2 m²/g (i.e., Cells 3-5). Although the initial discharge capacities of the experimental electrochemical cells with the lowest surface area nickel (Cells 4 and 5) are reduced as compared to that of the Comparative electrochemical cell (Cell 1), the degradation in the capacity (i.e. the capacity loss) was much lower in the Cells 4 and 5, particularly for the lowest surface area nickel (Cell 5).

FIG. 7 shows the same data as shown in FIG. 6 but normalized to initial capacity to highlight the decrease in capacity loss rate when lower surface area nickel is used. It can be clearly observed from FIG. 7 that the Cells 4 and 5 show a capacity loss of about 23 percent and 10 percent, respectively, after about 700 cycles, which is significantly lower than a capacity loss of more than about 37 percent for the Comparative electrochemical cell (Cell 1).

Thus, it is clear from the above results that an electrochemical cell having the cathode composition in accordance with some embodiments, exhibits improved resistance to capacity loss during cycling with low discharge rates as compared to a similar electrochemical cell having a high surface area electroactive metal.

While several aspects of the present disclosure have been described and depicted herein, alternative aspects may be affected by those skilled in the art to accomplish the same objectives. Accordingly, it is intended by the appended claims to cover all such alternative aspects as fall within the true spirit and scope of the disclosure.

What is claimed is:

1. A cathode composition, comprising:
an alkali metal halide; and
an electroactive metal comprising a first population of particles present in a range at least about 50 weight percent of a total weight of the electroactive metal, wherein a specific surface area of the first population of particles is lower than 0.2 m²/g.

2. The cathode composition of claim 1, wherein the electroactive metal comprises nickel, iron, chromium, copper, cobalt, manganese, zinc, or combinations thereof.

3. The cathode composition of claim 1, wherein the electroactive metal comprises nickel, iron or a combination thereof.

4. The cathode composition of claim 1, wherein the first population of particles consists essentially of nickel.

5. The cathode composition of claim 1, wherein the specific surface area of the first population of particles is in a range from about 0.05 m²/g to about 0.18 m²/g.

6. The cathode composition of claim 1, wherein the first population of particles has a particle size distribution having a d₅₀ value in a range from about 5 microns to about 20 microns.

7. The cathode composition of claim 1, wherein the electroactive metal further comprises a second population of particles, wherein a specific surface area of the second population of particles is greater than about 0.4 m²/g.

8. The cathode composition of claim 7, wherein the specific surface area of the second population of particles is in a range from about 0.4 m²/g to about 2.0 m²/g.

9. The cathode composition of claim 7, wherein an amount of the second population of particles is in a range of from about 1 weight percent to about 30 weight percent, based on the total weight of the electroactive metal.

10. The cathode composition of claim 1, wherein the alkali metal halide comprises a sodium halide, potassium halide, lithium halide, or combinations thereof.

11. The cathode composition of claim 1, further comprising an electrolyte that comprises a complex metal halide having a melting temperature in a range from about 120 degrees Celsius to about 300 degrees Celsius.

12. The cathode composition of claim 11, wherein the electrolyte comprises sodium tetrachloroaluminate (NaAlCl₄).

13. An electrochemical cell, comprising:
a first compartment comprising an alkali metal;
a second compartment comprising a cathode composition; wherein the cathode composition comprises:
an alkali metal halide;
an electroactive metal comprising a first population of particles present in a range at least about 50 weight percent of a total weight of the electroactive metal, wherein a specific surface area of the first population of particles is lower than 0.2 m²/g;
an electrolyte comprising a complex metal halide; and
a solid separator capable of transporting alkali metal ions between the first compartment and the second compartment.

14. The electrochemical cell of claim 13, wherein the specific surface area of the first population of particles is in a range from about 0.05 m²/g to about 0.18 m²/g.

15. The electrochemical cell of claim 13, wherein the electroactive metal further comprises a second population of particles, wherein a specific surface area of the second population of particles is greater than about 0.4 m²/g.

16. The electrochemical cell of claim 15, wherein the specific surface area of the second population of particles is in a range from about 0.4 m²/g to about 1 m²/g.

17. The electrochemical cell of claim 15, wherein an amount of the second population of particles is in a range from about 1 weight percent to about 30 weight percent, based on the total weight of the electroactive metal.

18. The electrochemical cell of claim 13, wherein the alkali metal comprises sodium, potassium, lithium, or combinations thereof.

19. An energy storage system comprising a plurality of electrochemical cells, wherein an electrochemical cell of the plurality of electrochemical cells, comprises:
a first compartment comprising an alkali metal;
a second compartment comprising a cathode composition; wherein the cathode composition comprises:
an alkali metal halide;
an electroactive metal comprising a first population of particles present in a range at least about 50 weight percent of a total weight of the electroactive metal, wherein a specific surface area of the first population of particles is lower than 0.2 m²/g;
an electrolyte comprising a complex metal halide; and
a solid separator capable of transporting alkali metal ions between the first compartment and the second compartment.
